(19) United States
(12) Patent Application Publication
(10) Pub. No.: US 2005/0089723 A1
(43) Pub. Date: Apr. 28, 2005

(54) Magnetic recording medium

(75) Inventors: Yasuhiro Nishida, Miyagi (JP); Takamitsu Harada, Miyagi (JP); Minoru Yamaga, Miyagi (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation

(21) Appl. No.: 10/970,932

(22) Filed: Oct. 22, 2004

(30) Foreign Application Priority Data
Oct. 23, 2003 (JP) P2003-362936

(51) Int. Cl. G11B 5/708; G11B 5/71

(52) U.S. Cl. 428/694 BN; 428/694 BP

(57) ABSTRACT

There is provided a magnetic recording medium which is well evaluated in a running reliability, has small amount of seizing on a magnetic head, suppresses a wear rate of the magnetic head, and maintains high reproduction power during running of the magnetic tape for a long time. The magnetic recording medium, in tape form, reproduces a magnetic recorded signal by a reproducing magnetic head utilizing a magnetoresistive effect element, and has a nonmagnetic layer including nonmagnetic powder dispersed in a binder, and a magnetic layer including ferromagnetic powder dispersed in a binder, the nonmagnetic layer and the magnetic layer are successively formed on a long tape-like nonmagnetic substrate, wherein the nonmagnetic layer contains the nonmagnetic powder having pH of 7.5 or more, and wherein the nonmagnetic layer or/and the magnetic layer contain at least one fatty acid amide having an alkyl group having 8 or more carbon atoms.

### CROSS REFERENCE TO RELATED APPLICATIONS

The present document is based on Japanese Priority Document JP2003-362936, filed in the Japanese Patent Office on Oct. 23 2003, the entire contents of which being incorporated herein by reference.

### BACKGROUND OF THE INVENTION

1. Field of the Invention

The present invention relates to a high-density recording type, tape-form magnetic recording medium used for recording computer data, and more particularly to a magnetic tape used in a magnetic recording-reproducing system using a magnetoresistive reproducing head (MR head).

2. Description of Related Art

Recently, in magnetic recording-reproducing systems for recording and reproducing computer data, a system having incorporated a so-called thin film magnetic head has been put into practical use.

The thin film magnetic head is easy to miniaturize, and can be easily processed into a multi-track head, and therefore, especially in systems using a magnetic tape as a recording medium, a multi-track fixed head comprised of the thin film magnetic head is widely used.

The use of the thin film magnetic head, which can be easily miniaturized, improves the track density and recording efficiency, thus achieving high-density recording, and further the thin film magnetic head processed into multi-track head can improve the data transfer rate.

The thin film magnetic head is roughly classified into an inductive head responding to a change of a magnetic flux with time, and a magnetoresistive head (MR head) responding to the magnitude of a magnetic flux and utilizing a magnetoresistance effect.

The inductive head has a flat structure and hence is small in the number of winding of the head coil, namely, difficult to increase the magnetomotive force, and therefore has a problem in that a satisfactory reproduction power cannot be obtained. For this reason, currently, an MR head which can produce higher reproduction power is widely used for reproduction, and, on the other hand, an inductive head is used for recording.

These heads for recording and reproduction are generally in a unified form (composite form) and incorporated into a system. The above magnetic recording system employs a linear recording mode which can achieve faster data transfer.

The magnetic tapes for recording computer data used in the magnetic recording-reproducing systems having an MR head incorporated are specified system by system. For example, magnetic tapes meeting the 3480 type, 3490 type, 3590 type, and 3570 type according to the standards of IBM are known, and these magnetic tapes have a basic structure in which a magnetic layer having a single-layer structure comprising ferromagnetic powder and a binder, and having a thickness as relatively large as about 2.0 to 3.0 μm is formed on a nonmagnetic substrate.

However, the magnetic tape having a magnetic layer of the so-called single-layer structure has a problem in that it does not satisfactorily meet the demands of magnetic recording medium which can store large capacity data currently used.

For solving the problem, for example, a magnetic recording medium (magnetic tape) which comprises a lower nonmagnetic layer comprising inorganic nonmagnetic powder dispersed in a binder, and a thin upper magnetic layer comprising ferromagnetic metal powder dispersed in a binder successively stacked on a nonmagnetic substrate has been proposed (see, for example, Patent document 1). When the magnetic recording medium of this type is used in a magnetic recording system having a thin film magnetic head incorporated, the upper magnetic layer can be reduced in thickness by virtue of the structure of the recording medium, so that the lowering of the power due to a thickness loss is suppressed and further high recording density can be achieved, and therefore, this magnetic tape has an advantage in that it can store data in a large capacity, as compared to the magnetic tape having a magnetic layer of a single-layer structure.

[Patent Document 1]

Japanese Patent Application Publication No. Hei 9-35245

### SUMMARY OF THE INVENTION

However, when the magnetic tape is used in a magnetic recording-reproducing system using a magnetoresistive reproducing head (MR head), a deposit called “seizing” is generated on the MR head portion, leading to a problem in that the performance is lowered. The cause of this is considered that the MR head rubbing against the magnetic tape has a higher temperature than the temperatures of other magnetic tape sliding surfaces. The deposit causes no problem in the inductive magnetic head conventionally used for recording. However, in the recording-reproducing system using a high-sensitive magnetic head, such as an MR head, the deposit poses a serious problem from a practical point of view.

Further, in a magnetic recording-reproducing system having a voltage applied to the shield portion of the magnetoresistive magnetic head for reproduction, a phenomenon such that the “seizing” on the magnetic head portion is changed to a conductor to cause noise to go into the magnetoresistive element, thus rapidly increasing the error rate, has been confirmed.

For meeting the increasing demands of higher-density and higher-capacity recording, the shortest recording wavelength tends to be smaller, and hence, the above-mentioned “seizing” directly adversely affects the error rate as a spacing loss.

Specifically, it has been confirmed that, when the shortest recording wavelength is less than 0.6 μm, the effect of the “seizing” on the error rate is remarkable, and, when the shortest recording wavelength is less than 0.4 μm, the effect is more remarkable.

In view of the above problems, the present inventors have conducted extensive and intensive studies with a view toward developing a tape-form magnetic recording medium used in a magnetic recording-reproducing system utilizing a linear recording mode and having a magnetoresistive reproducing head incorporated thereinto. As a result, the inventers have found that, when the “seizing” especially on the magnetoresistive reproducing head is suppressed to lower the spacing loss, higher running reliability can be realized, and further found that, in a magnetic recording-reproducing system having a voltage applied to the shield portion of the magnetoresistive reproducing head, the “seizing” on the reproducing magnetic head portion changes to a conductor and causes noise to go into the magnetoresistive element, thus rapidly increasing the error rate, and therefore, the inventers provide a magnetic recording medium which suppresses the “seizing” to lower the error rate.

According to an embodiment of the present invention, there is provided a magnetic recording medium which reproduces a magnetic recorded signal by a reproducing magnetic head utilizing a magnetoresistive effect element. The magnetic recording medium includes a nonmagnetic layer in which non magnetic powder is dispersed in a binder, and a magnetic layer in which ferromagnetic powder is dispersed in a binder, the nonmagnetic layer and the magnetic layer are successively formed on a nonmagnetic substrate, wherein the nonmagnetic layer contains the nonmagnetic powder having pH of 7.5 or more, and wherein the nonmagnetic layer or/and the magnetic layer contain at least one fatty acid amide having an alkyl group having 8 or more carbon atoms.

The magnetic recording medium of the present embodiment is advantageous not only in that it has excellent running reliability and it can effectively suppress the “seizing” on the magnetic head, but also in that wear of the magnetic head due to sliding can be reduced and high reproduction power can be maintained during running of the magnetic recording medium for a long time.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a diagrammatic cross-sectional view of one example of a magnetic recording medium according to an embodiment of the present invention; and

FIG. 2 is a diagrammatic view showing one step in the double-layer co-application of a nonmagnetic layer and a magnetic layer.

### DETAILED DESCRIPTION OF THE EMBODIMENTS

Hereinbelow, embodiments of the magnetic recording medium according to the present invention will be described with reference to the drawings, but the following examples should not be construed as limiting the scope of the present invention, and conventionally known materials, structures and the like can be appropriately used and changed as long as the desired effects of the present invention are not sacrificed.

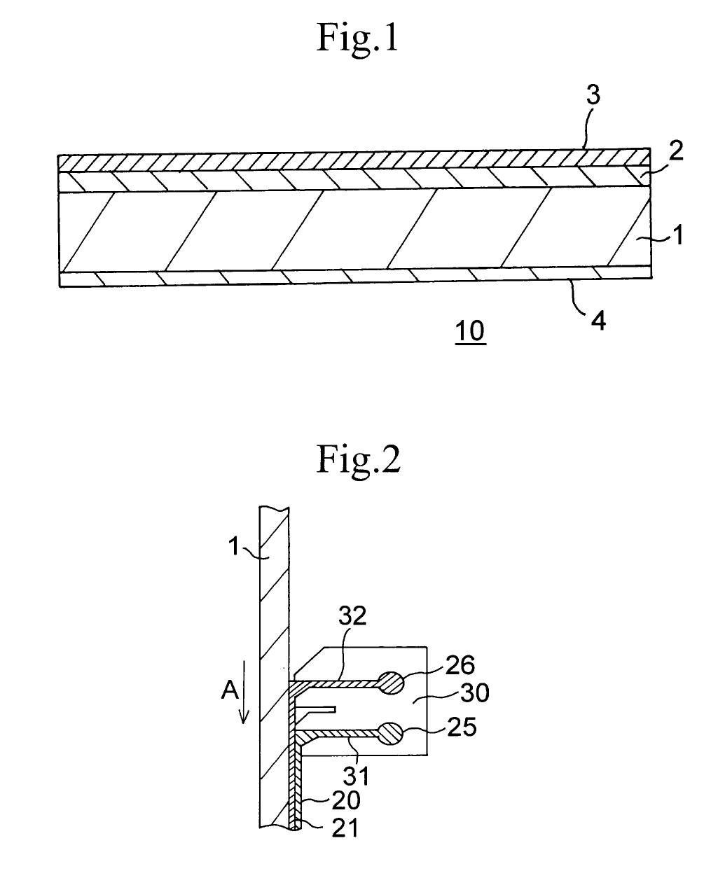

FIG. 1 shows a diagrammatic cross-sectional view of the magnetic recording medium of the present invention. A magnetic recording medium 10 has a construction in which a nonmagnetic layer 2 including nonmagnetic powder dispersed in a binder and a magnetic layer 3 including ferromagnetic powder dispersed in a binder are successively stacked on a nonmagnetic substrate 1 in a long tape-like form.

As a material for the nonmagnetic substrate 1, any conventionally known substrate for use in magnetic tape can be used. Examples include polyesters, such as polyethylene terephthalate and polyethylene naphthalate; polyolefins, such as polyethylene and polypropylene; cellulose derivatives, such as cellulose triacetate, cellulose diacetate, and cellulose acetate butyrate; vinyl resins, such as polyvinyl chloride and polyvinylidene chloride; and plastics, such as polycarbonate, polyimide, polyamide, and polyamideimide.

Next, the nonmagnetic layer 2 is described. The nonmagnetic layer 2 is comprised mainly of nonmagnetic powder, a binder, and a lubricant.

Fist, an explanation is made on the nonmagnetic powder contained in the nonmagnetic layer 2.

Examples of nonmagnetic powder include α-Fe₂O₃, TiO₂, carbon black, graphite, barium sulfate, ZnS, MgCO₃, CaCO₃, ZnO, CaO, tungsten disulfide, molybdenum disulfide, boron nitride, MgO, SnO₂, Cr₂O₃, α-Al₂O₃, α-FeOOH, SiC, cerium oxide, corundum, artificial diamond, α-iron oxide, garnet, silica, silicon nitride, boron nitride, silicon carbide, molybdenum carbide, boron carbide, tungsten carbide, titanium carbide, tripoli, diatomaceous earth, and dolomite. Of these, inorganic powder, such as α-Fe₂O₃, TiO₂, carbon black, CaCO₃, barium sulfate, α-Al₂O₃, α-FeOOH, or Cr₂O₃, or polymer powder of polyethylene or the like can be preferably used.

The majority (50% or more) of the nonmagnetic powder contained in the nonmagnetic layer 2 has pH of 7.5 or more.

The pH of the nonmagnetic powder is an index of the relative ratio between the amount of the acidic functional groups and the amount of the basic functional groups present on the surface of the nonmagnetic powder. For example, the pH of higher than 7 of the nonmagnetic powder indicates that the amount of the basic functional groups on the surface of the nonmagnetic powder is relatively large. On the other hand, the pH of lower than 7 of the nonmagnetic powder indicates that the amount of the acidic functional groups on the surface of the nonmagnetic powder is relatively large.

With respect to the pH of the nonmagnetic powder contained in the nonmagnetic layer 2, there is no particular limitation as long as it is 7.5 or more, but, when, for example, alumina is used, the pH is preferably 11 or less.

When the pH of the nonmagnetic powder contained in the nonmagnetic layer 2 is less than 7.5, that is, the amount of the acidic functional groups in the nonmagnetic layer 2 is relatively large, a basic lubricant undergoes acid-base interaction with the acidic functional groups on the surface of the nonmagnetic powder, so that the lubricant is adsorbed on the nonmagnetic layer 2 and hence is not supplied to the surface of the magnetic recording medium 10, causing a disadvantage in that a desired lubricating effect cannot be obtained.

In view of the above disadvantage, for obtaining a desired lubricating effect when the pH of the nonmagnetic powder is less than 7.5, an increase of the lubricant content is considered. However, when the lubricant content is increased, the dispersibility of the lubricant in the nonmagnetic layer 2 and the below-described magnetic layer 3 becomes poor, lowering the surface roughness or film strength of the magnetic recording medium 10. As a result, a problem occurs in that the electromagnetic conversion properties deteriorate or the durability of the magnetic recording medium becomes poor due to the lowering of the film strength. For the above reasons, the pH of the nonmagnetic powder contained in the nonmagnetic layer 2 is 7.5 or more.

In addition, a similar theory can be applied to the content of the nonmagnetic powder having pH of 7.5 or more contained in the nonmagnetic layer 2. Specifically, when the content of the nonmagnetic powder having pH of 7.5 or more is as small as less than 50%, the lubricant content is required to be increased for obtaining a desired lubricating effect. However, when the lubricant content is increased, the dispersibility of the lubricant in the nonmagnetic layer 2 and the below-described magnetic layer 3 becomes poor, lowering the surface roughness or film strength. As a result, a problem occurs in that the electromagnetic conversion properties deteriorate or the durability of the magnetic recording medium becomes poor due to the lowering of the film strength. Therefore, it is desired that the majority of the nonmagnetic powder contained in the nonmagnetic layer 2 has pH of 7.5 or more.

The pH of the nonmagnetic powder can be controlled by depositing a metal oxide on the surface of the nonmagnetic powder. For example, when increasing the pH, Al₂O₃ is deposited on the surface of the nonmagnetic powder. On the other hand, when lowering the pH, SiO₂ is deposited on the surface of the nonmagnetic powder. The control of the pH of the nonmagnetic powder is not limited to the method using a metal oxide, and a conventionally known method may be used.

The binder to be contained in the nonmagnetic layer 2 is selected considering the surface properties, i.e., the dispersibility of the nonmagnetic pigment and the uniformity of the interface between the upper and lower layers. As the binder which satisfies these properties, like in the binder contained in the upper layer (magnetic layer 3), a conventionally known thermoplastic resin, thermosetting resin, or cross-linking resin by irradiation with an electron beam or the like, or a mixture of thereof can be used.

Next, an explanation is made on the lubricant incorporated into the nonmagnetic layer 2.

As the lubricant, at least one fatty acid amide having an alkyl group having 8 or more carbon atoms is used. The lubricant may be contained in the below-described magnetic layer 3 or in both the nonmagnetic layer 2 and the magnetic layer 3.

When the alkyl group constituting the fatty acid amide has less than 8 carbon atoms, the action of the fatty acid amide as a lubricant is unsatisfactory, making it impossible to suppress the “seizing” on the magnetoresistive reproducing head.

Further, it is preferred that the alkyl group constituting the fatty acid amide has 24 or less carbon atoms. When the alkyl group has more than 24 carbon atoms, the coefficient of friction of the resultant magnetic recording medium may be increased. The alkyl group constituting the fatty acid amide may be either linear or branched. Further, the alkyl group may contain a double bond.

The amount of the fatty acid amide having an alkyl group having 8 or more carbon atoms is preferably 0.1 to 20 parts by weight, further desirably 0.2 to 5 parts by weight, relative to 100 parts by weight of the nonmagnetic powder contained in the nonmagnetic layer 2.

Further, as the lubricant contained in the nonmagnetic layer 2, in addition to the above-mentioned fatty acid amide, the following can be used. Examples include fatty acid esters, fatty acids having 8 to 22 carbon atoms, and aliphatic alcohols. Further, silicone oil, graphite, molybdenum disulfide, boron nitride, graphite fluoride, fluorine alcohol, polyolefin (e.g., polyethylene wax), polyglycol (e.g., polyethylene oxide wax), alkylphosphate ester, thiophosphite ester, polyphenyl ether, or tungsten disulfide can be used.

In specific examples of the lubricants comprised of these organic compounds, examples of fatty acids include capric acid, caprylic acid, lauric acid, myristic acid, palmitic acid, stearic acid, behenic acid, oleic acid, elaidic acid, linoleic acid, linolenic acid, and isostearic acid.

Examples of esters include butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, and tridecyl stearate, and examples of alcohols include oleyl alcohol, stearyl alcohol, and lauryl alcohol.

Further, it is preferred that the nonmagnetic layer 2 contains various additives, such as an antistatic agent in addition to the above-described main components.

Examples of antistatic agents include conductive fine powder, such as carbon black and carbon black graft polymers; natural surfactants, such as saponin; alkylene oxide, glycerol, and glycidol nonionic surfactants; cationic surfactants, such as higher alkylamines, quaternary ammonium salts, salts of a heterocyclic compound, e.g., pyridine or the like, and phosphonium or sulfonium salts; anionic surfactants having an acid group, such as a carboxylic acid, phosphoric acid, a sulfate ester group, or a phosphoric ester group; and amphoteric surfactants, such as amino acids, aminosulfonic acids, and amino ester-containing sulfates or phosphoric esters.

When the above conductive fine powder is used as an antistatic agent, the amount of the powder used is preferably 1 to 15 parts by weight, relative to 100 parts by weight of the nonmagnetic pigment, and, when the surfactant is used as an antistatic agent, the amount of the surfactant used is preferably 1 to 15 parts by weight, relative to 100 parts by weight of the nonmagnetic pigment.

Further, the nonmagnetic layer 2 may contain inorganic particles having a Mohs hardness of 5 or more like in the below-described magnetic layer 3.

Examples of inorganic particles having a Mohs hardness of 5 or more include Al₂O₃ (Mohs hardness: 9), TiO (Mohs hardness: 6), TiO₂ (Mohs hardness: 6.5), SiO₂ (Mohs hardness: 7), SnO₂ (Mohs hardness: 6.5), Cr₂O₃ (Mohs hardness: 9), and α-Fe₂O₃ (Mohs hardness: 5.5), and these can be used individually or in combination.

Next, the magnetic layer 3 is described.

The magnetic layer is formed by applying a coating composition which is comprised mainly of ferromagnetic powder, a binder, and a lubricant, and which may contain other additives.

With respect to the ferromagnetic powder contained in the magnetic layer 3, there is no particular limitation, and any magnetic materials for use in conventionally known so-called coating type magnetic tapes can be used. Examples include ferromagnetic alloy powder, ferromagnetic hexagonal system ferrite powder, ferromagnetic iron oxide particles, and fine particles of ferromagnetic CrO₂, ferromagnetic cobalt ferrite (CoO—Fe₂O₃), cobalt adsorbed oxide, iron nitride, and the like.

As the ferromagnetic alloy powder, Fe alloy powder, Co alloy powder, Ni alloy powder, Fe—Co, Fe—Ni, Fe—Co—Ni, Co—Ni, Fe—Co—B, Fe—Co—B, Mn—Bi, Mn—Al, or Fe—Co—V alloy powder, or alloy powder comprised of a compound of the above alloy and another element can be used. For further improving the properties, Al or a nonmetal, such as Si, P, B, or C, may be incorporated into the composition of the ferromagnetic powder.

Generally, for chemically stabilizing the particle surface of the metal powder, an oxide layer is formed on the particle surface. Examples of methods for forming an oxide include known gradual oxidation treatments, i.e., a method in which the metal powder is immersed in an organic solvent and then dried, a method in which the metal powder is immersed in an organic solvent and then oxygen-containing gas is fed thereto to form an oxide film on the surface, followed by drying, and a method in which, using no organic solvent, the partial pressures of oxygen gas and inert gas are controlled to form an oxide film on the surface, and metal powder treated by any method can be used.

Examples of ferromagnetic hexagonal system ferrite powder include ferromagnetic powder which is in a plate form, and which has an easy axis of magnetization in the direction perpendicular to the surface of the plate, such as barium ferrite, strontium ferrite, lead ferrite, calcium ferrite, and cobalt substituted materials thereof, and, of these, especially preferred are a cobalt substituted material of barium ferrite and a cobalt substituted material of strontium ferrite. Further, for improving the properties if necessary, an element, such as In, Zn, Ge, Nb, or V, may be added. The hexagonal system ferrite powder has a feature such that the power in the long-wavelength recording is low, as compared to the power of other magnetic particles, but, in the short-wavelength recording in which the shortest recording wavelength in a high frequency band is 1.5 μm or less, preferably 1.0 μm or less, a power higher than the power of other magnetic particles can be expected.

With respect to the form of the ferromagnetic powder, there is no particular limitation, and examples include needle-like form, particulate form, cube form, ellipsoid form, and plate form. When the ferromagnetic powder is in a needle-like form, it preferably has an aspect ratio of about 3/1 to 30/1, further preferably 4/1 or more. From the viewpoint of obtaining excellent electromagnetic conversion properties, the ferromagnetic powder preferably has a specific surface area of 40 m²/g or more, further preferably 45 m²/g or more.

As the binder contained in the magnetic layer 3, a thermoplastic resin, a thermosetting resin, or a cross-linking resin by irradiation with an electron beam or the like for use in conventionally known coating type magnetic layer, or a mixture of these can be appropriately used.

As the thermoplastic resin, preferred is one having a softening temperature of 150° C. or lower, an average molecular weight of 5,000 to 50,000, and a degree of polymerization of about 50 to 500. Examples include vinyl chloride, vinyl acetate, vinyl chloride-vinyl acetate copolymers, vinyl chloride-vinylidene chloride copolymers, vinyl chloride-acrylonitrile copolymers, acrylate ester-acrylonitrile copolymers, acrylate ester-vinyl chloride-vinylidene chloride copolymers, vinyl chloride-acrylonitrile copolymers, acrylate ester -acrylonitrile copolymers, acrylate ester-vinylidene chloride copolymers, methacrylate ester-vinylidene chloride copolymers, methacrylate ester-vinyl chloride copolymers, methacrylate ester-ethylene copolymers, polyvinyl fluoride, vinylidene chloride-acrylonitrile copolymers, acrylonitrile-butadiene copolymers, polyamide resins, polyvinyl butyral, cellulose derivatives (cellulose acetate butyrate, cellulose diacetate, cellulose triacetate, cellulose propionate, nitrocellulose), styrene-butadiene copolymers, polyurethane resins, polyester resins, amino resins, synthetic rubbers, and mixtures thereof.

Examples of thermosetting resins include phenolic resins, epoxy resins, polyurethane curing resins, urea resins, melamine resins, alkyd resins, silicone resins, polyamine resins, and urea formaldehyde resins.

When the above resin used as a binder has in its molecule an acid group, such as —SO₃H, —OSO₃H, —PO₃H, —OPO₃H₂, or —COOH, or a salt thereof, or a polar group, such as a hydroxyl group, an epoxy group, or an amino group, more excellent dispersibility and film durability can be obtained. Of these, preferred is one having an —SO₃Na, —COOH, —OPO₃Na₂, or —NH₂ group.

It is preferred that the magnetic layer 3 contains inorganic particles having a Mohs hardness of 5 or more.

With respect to the material for the inorganic particles, there is no particular limitation as long as it has a Mohs hardness of 5 or more. Examples of inorganic particles having a Mohs hardness of 5 or more include Al₂O₃ (Mohs hardness: 9), TiO (Mohs hardness: 6), TiO₂ (Mohs hardness: 6.5), SiO₂ (Mohs hardness: 7), SnO₂ (Mohs hardness: 6.5), Cr₂O₃ (Mohs hardness: 9), and α-Fe₂O₃ (Mohs hardness: 5.5), and these can be used individually or in combination. Especially preferred are inorganic particles having a Mohs hardness of 8 or more.

When using relatively soft inorganic particles having a Mohs hardness of less than 5, the inorganic particles are easily removed from the magnetic layer 3 and an abrasive effect on the magnetic head cannot be obtained, so that clogging of the magnetic head is likely to occur and the running durability is lowered.

The amount of the above inorganic particles may be 0.1 to 20 parts by weight, preferably in the range of 1 to 10 parts by weight, relative to 100 parts by weight of the ferromagnetic powder.

In the preparation of the coating composition for the magnetic layer 3, in addition to the above-described main components, various additives, such as an antistatic agent, may be used.

Examples of antistatic agents include conductive fine powder, such as carbon black and carbon black graft polymers; natural surfactants, such as saponin; alkylene oxide, glycerol, and glycidol nonionic surfactants; cationic surfactants, such as higher alkylamines, quaternary ammonium salts, salts of a heterocyclic compound, e.g., pyridine or the like, and phosphonium or sulfonium salts; anionic surfactants having an acid group, such as a carboxylic acid, phosphoric acid, a sulfate ester group, or a phosphoric ester group; and amphoteric surfactants, such as amino acids, aminosulfonic acids, and amino ester-containing sulfates or phosphoric esters.

Further, as the lubricant incorporated into the magnetic layer 3, it is desired to use at least one fatty acid amide having an alkyl group having 8 or more carbon atoms contained in the nonmagnetic layer 2.

When the magnetic layer 3 contains a fatty acid amide, the amount of the fatty acid amide contained is preferably 0.1 to 20 parts by weight, more preferably 0.2 to 5 parts by weight, relative to 100 parts by weight of the ferromagnetic powder.

Specific examples of fatty acid amides having an alkyl group having 8 or more carbon atoms include lauric acid amide, myristic acid amide, palmitic acid amide, stearamide, oleamide, and erucamide, and these can be used individually or in combination.

Further, as the lubricant incorporated into the magnetic layer, in addition to the above-mentioned fatty acid amide, the following can be used.

Examples include fatty acid esters, fatty acids having 8 to 22 carbon atoms, and aliphatic alcohols.

Further, silicone oil, graphite, molybdenum disulfide, boron nitride, graphite fluoride, fluorine alcohol, polyolefin (e.g., polyethylene wax), polyglycol (e.g., polyethylene oxide wax), alkylphosphate ester, thiophosphite ester, polyphenyl ether, or tungsten disulfide can be used.

In specific examples of the lubricants comprised of these organic compounds, examples of fatty acids include capric acid, caprylic acid, lauric acid, myristic acid, palmitic acid, stearic acid, behenic acid, oleic acid, elaidic acid, linoleic acid, linolenic acid, and isostearic acid.

Examples of esters include butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, and tridecyl stearate, and examples of alcohols include oleyl alcohol, stearyl alcohol, and lauryl alcohol.

The so-called “seizing” caused by sliding of the magnetic head and the magnetic recording medium 10 constitutes spacing of the magnetic head, and, in the magnetic recording medium 10 of the present invention, the adverse effect of the spacing is remarkable when the shortest recording wavelength of the magnetic recording-reproducing system used is 0.6 μm or less, and the adverse effect is more remarkable when the shortest recording wavelength is 0.4 μm or less.

Therefore, the magnetic recording-reproducing system in which the magnetic recording medium 10 of the present invention exhibits desired effects is preferably a magnetic recording-reproducing system having a shortest recording wavelength of 0.6 μm or less, further preferably 0.4 μm or less.

Further, it has been found that the “seizing” also depends on the abrasive force of the magnetic recording medium 10. For example, it has been confirmed that, by using a magnetic recording medium having a sendust bar wear depth of 8 to 40 μm as measured at a humidity of 50% RH at a temperature of 23° C., an increase of the “seizing” can be suppressed. When the sendust wear depth of the magnetic recording medium is smaller than 8 μμm, the ability of abrading the seizing is unsatisfactory, thus increasing the seizing. On the other hand, when the sendust wear depth is larger than 40 μm, the magnetic recording medium abrades also the magnetic head, thus shortening the life of the head.

From the above, the sendust bar wear depth of the magnetic recording medium as measured under conditions at a humidity of 50% RH at a temperature of 23° C. is preferably 8 to 40 μm, further desirably 10 to 30 μm.

Next, the process for producing the magnetic recording medium 10 of the present invention will be described.

First, a base film constituting the nonmagnetic substrate 1 is prepared.

As a constituent material of the nonmagnetic substrate 1, polyester, such as polyethylene terephthalate or polyethylene naphthalate, polyolefin, such as polypropylene, a cellulose derivative, such as cellulose triacetate or cellulose diacetate, a vinyl resin, such as polyvinyl chloride, a plastic, such as polycarbonate, polyamide, or polysulfone, a metal, such as aluminum or copper, or ceramic, such as glass, can be used.

Prior to the below-described application step for the nonmagnetic layer, the substrate may be subjected to surface treatment, such as corona discharge treatment, plasma treatment, primary coat treatment, thermal treatment, dust removing treatment, metal deposition treatment, or alkali treatment.

Next, the above-mentioned nonmagnetic powder, binder, lubricant, and other additives are kneaded with a predetermined solvent to prepare a coating composition for forming the nonmagnetic layer 2.

Further, ferromagnetic powder, a binder, and, if necessary, another filler, additive, and the like are kneaded with a solvent to prepare a magnetic coating composition.

Examples of solvents used in kneading of these coating compositions include ketone solvents, such as acetone, methyl ethyl ketone, methyl isobutyl ketone, and cyclohexanone; alcohol solvents, such as methanol, ethanol, and propanol; ester solvents, such as methyl acetate, ethyl acetate, butyl acetate, propyl acetate, ethyl lactate, and ethylene glycol acetate; ether solvents, such as diethylene glycol dimethyl ether, 2-ethoxyethanol, tetrahydrofuran, and dioxane; aromatic hydrocarbon solvents, such as benzene, toluene, and xylene; and halogenated hydrocarbon solvents, such as methylene chloride, ethylene chloride, carbon tetrachloride, chloroform, and chlorobenzene, and these may be appropriately used in combination.

With respect to the method for kneading, there is no particular limitation, and the order of adding the components can be appropriately selected.

In the preparation of the magnetic coating composition, a general kneading machine, for example, a sand mill, a dynomill, a double-cylinder pearl mill, a two-roll mill, a three-roll mill, a ball mill, a high-speed impeller dispersing machine, a high-speed stone mill, a high-speed impact mill, an extruder, a dispersion kneader, a high-speed mixer, a homogenizer, or an ultrasonic dispersing machine can be used.

The coating composition may be applied to the layer forming surface either directly or through a functional layer, such as a bonding layer. Examples of coating methods include air doctor coating, blade coating, rod coating, extrusion coating, air-knife coating, squeeze coating, dip coating, reverse-roll coating, transfer roll coating, gravure coating, kiss-roll coating, cast coating, spray coating, and spin coating methods, and, as an especially preferred example, there can be mentioned a so-called wet-on-wet coating method in which a coating composition for forming the nonmagnetic layer and a coating composition for forming the magnetic layer are co-applied and stacked on one another in a wet state.

FIG. 2 shows one step in the wet-on-wet coating method.

In this method, a film-form nonmagnetic substrate 1 is fed from a feed roll in the direction indicated by an arrow A, and two layers of coating compositions 21, 20 for respectively forming a nonmagnetic layer 2 and a magnetic layer 3 are co-applied to the substrate by means of an extrusion coater 30 in an extrusion mode.

The extrusion coater 30 has reservoir portions 25, 26, and the coating compositions 20, 21 are fed through, respectively, slits 31, 32 and co-applied by a wet-on-wet coating method.

In a so-called double-layer co-application method in accordance with the wet-on-wet coating method, the magnetic coating composition for upper layer is applied to the lower layer which is still wet, and hence not only does the surface of the lower layer (that is, border between the lower layer and the upper layer) become smooth, but also the surface properties of the upper layer are excellent, and the bonding between the upper and lower layers is improved. As a result, the resultant recording medium satisfies the properties of a magnetic recording medium required to have high power and low noise especially for achieving high-density recording, and further the film is prevented from peeling, thus improving the film strength. Further, the occurrence of drop out can be suppressed, improving the reliability.

The thickness of the magnetic layer 3 applied as mentioned above is preferably 1.5 μm or less, further preferably 1.0 μm or less, most preferably 0.5 μm or less.

The thickness of the nonmagnetic layer 2 is appropriately determined depending on the purpose of the use, preferably 0.5 to 3.0 μm.

The thickness of the nonmagnetic substrate 1 is appropriately determined depending on the purpose of the use, preferably, for example, about 2 to 10 μm.

The magnetic layer 3 applied onto the nonmagnetic substrate is subjected to treatment for orientation of the ferromagnetic material in the magnetic layer, i.e., magnetic field orientation treatment, followed by drying treatment. If necessary, the resultant layer is subjected to surface smoothing treatment.

In the orientation, it is preferred that the position of the film to be dried is controlled by changing the temperature and flow rate of drying air and the application speed, and the application speed is preferably 20 to 1,000 m/min and the temperature of drying air is preferably 60° C. or higher. Further, prior to the magnet zone, appropriate predrying may be conducted.

As a roll for surface smoothing treatment, a heat-resistant plastic roll comprised of, for example, epoxy, polyimide, polyamide, or polyimideamide, or a metal roll is used. The temperature for the treatment is preferably 50° C. or higher, further preferably 100° C. or higher. The linear pressure is preferably 200 kg/cm or more, further desirably 300 kg/cm or more.

Further, a backing layer 4 may be formed by a conventionally known method on the other main surface of the nonmagnetic substrate on the opposite side of the surface on which the magnetic layer is formed.

### EXAMPLES

Hereinbelow, the magnetic recording medium of the present invention will be described with reference to the following specific Examples.

The components, formulations, and procedure shown below can be appropriately changed or modified as long as the desired effects of the present invention are not sacrificed, and the following Examples should not be construed as limiting the scope of the present invention.

(Sample 1)

In the present Example, a magnetic recording medium comprising a nonmagnetic layer 2 and a magnetic layer 3 stacked on a nonmagnetic substrate 1, and a backing layer 4 formed on the other main surface of the nonmagnetic substrate on the opposite side of the surface on which the magnetic layer is formed was prepared as a sample.

First, a magnetic coating composition for forming the magnetic layer 3 and a nonmagnetic coating composition for forming the nonmagnetic layer 2 were prepared.

Each composition was prepared by a general preparation method, and, in each composition, first, a pigment (ferromagnetic powder or nonmagnetic powder), a binder, an additive, a solvent, and the like were mixed together, and then kneaded by means of a kneader so that the nonvolatile content became 85% by weight during the kneading. Then, the magnetic coating composition was dispersed by means of a sand mill for 5 hours or the nonmagnetic coating composition was dispersed by means of a sand mill for 3 hours to obtain each coating composition.

Formulations of the coating compositions are shown below.

(Formulation of Magnetic Coating Composition)

Ferromagnetic metal powder: 100 Parts by weight

{composition: Fe:Co=90:10 (atomic ratio)}

Coercive force (Hc): 147 kA/m {1,850 oersteds (Oe)}

Specific surface area, as measured by a BET method: 58 m²/g

Crystallite size: 1,750 nm

Saturation magnetization (δs): 130 A·m²/kg (130 emu/g)

Particle size (average longer axis diameter): 0.10 μm

Aspect ratio: 7.0

Polar group (—SO₃K group)-containing vinyl chloride copolymer: 12 Parts by weight

{—SO₃K group content: 5×10⁻⁶ mol/g; degree of polymerization: 350; epoxy group content: 3.5% by weight, in terms of a monomer unit (MR-110, manufactured and sold by ZEON CORPORATION.)}

Polar group (—SO₃Na group)-containing polyester polyurethane resin: 3 Parts by weight

{neopentyl glycol/caprolactone polyol/diphenylmethane 4,4′-diisocyanate (MDI)=0.9/2.6/1 (weight ratio); —SO₃Na group content: 1×10⁻⁴ mol/g}

α-Alumina {(particle size: 0.2 μm)}: 5 Parts by weight

Carbon black {(particle size: 0.08 μm)}: 0.5 Part by weight

Butyl stearate: 1 Part by weight

Stearic acid: 2 Parts by weight

Methyl ethyl ketone: 150 Parts by weight

Cyclohexanone: 50 Parts by weight

(Formulation of Nonmagnetic Coating Composition)

Nonmagnetic pigment: needle-like α-iron oxide: 100 Parts by weight

(specific surface area: 53 m²/g; longer axis length: 0.15 μm; aspect ratio: 11)

Binder: polyvinyl chloride resin: 25 Parts by weight

{functional group (—SO₃K)=6×10⁻⁵ mol/g}

Antistatic agent: carbon black: 15 Parts by weight

(Ketjenblack EC; manufactured and sold by LION AKZO CO., LTD.)

Solvent: methyl ethyl ketone: 150 Parts by weight

Solvent: cyclohexanone: 150 Parts by weight

To the above-prepared magnetic coating composition was added 0.5 part by weight of capric acid amide as an alkylamide, and the resultant mixture was stirred for 30 minutes, and then, as a curing agent, 3 parts by weight of polyisocyanate (Coronate L; manufactured and sold by NIPPON POLYURETHANE INDUSTRY CO., LTD.) was added to each of the magnetic coating composition and the nonmagnetic coating composition to prepare a magnetic coating composition and a nonmagnetic coating composition.

Two layers of the coating composition for magnetic layer and the coating composition for nonmagnetic layer were co-applied to a nonmagnetic substrate made of polyethylene naphthalate (PEN)(thickness: 6.0 μm; central line surface roughness: 5 nm) using a die coater shown in FIG. 2 so that the thickness of the dried nonmagnetic layer 2 became 2.0 μm and the thickness of the dried magnetic layer 3 on the nonmagnetic layer 2 became 0.20 μm.

Then, while both the layers were wet, the layers were subjected to orientation treatment using a cobalt magnet having a magnetic flux density of 0.3 T (3,000 gausses) and a solenoid having a magnetic flux density of 0.15 T (1,500 gausses). Then, the resultant layers were dried to form a nonmagnetic layer 2 and a magnetic layer 3.

(Ingredients for Forming Backing Layer)

Carbon black: 100 Parts by weight

(average primary particle size: 17 nm; DBP oil absorption: 75 ml/100 g; pH: 8.0; specific surface area, as measured by a BET method: 220 m²/g; volatile content: 1.5%; bulk density: 151 bs/ft³)

Nitrocellulose resin: 100 Parts by weight

Polyester polyurethane resin: 30 Parts by weight

[(Nippolane, manufactured and sold by NIPPON POLYURETHANE INDUSTRY CO., LTD.]

Methyl ethyl ketone: 500 Parts by weight

Toluene: 500 Parts by weight

The above ingredients were prekneaded together, and kneaded by means of a roll mill. To 100 parts by weight of the resultant dispersion were added the ingredients below, and dispersed by means of a sand grinder.

The dispersion was filtered, and then, to 100 parts by weight of the resultant dispersion were added 120 parts by weight of methyl ethyl ketone and 5 parts by weight of polyisocyanate to prepare a coating composition for forming a backing layer.

Then, the coating composition for forming a backing layer was applied to the other main surface of the nonmagnetic substrate on the opposite side of the surface on which the magnetic layer was formed so that the thickness of the dried film became 0.5 μm, and dried to form a backing layer 4, thus obtaining a roll of a magnetic recording laminate comprising the nonmagnetic layer 2 and magnetic layer 3 formed on one main surface and the backing layer 4 formed on the other main surface.

The above-prepared roll of magnetic recording laminate was calendered through a 7-stage calendering machine comprised only of metallic rolls {temperature: 90° C.; linear pressure: 29.4 MPa (300 kg/cm²)}.

Then, the calendered magnetic recording medium laminate roll was cut into ½ inch in width.

Further, a lapping tape using an abrasive material having a particle size of 5 μm was moved by means of a rotating roll at a speed of 14.4 cm/min in the direction opposite to the tape feed direction (400 m/min), and pressed downwardly by a guide block and brought into contact with the surface of the tape magnetic layer, effecting a lapping treatment. In this instance, the magnetic tape feed tension was 100 g, and the tension of the lapping tape was 250 g.

580 m of the magnetic tape obtained was taken up by a DLT ½-inch cartridge, thus obtaining a magnetic recording medium 10 ultimately desired.

(Samples 2 to 6)

Samples 2 to 6 were individually prepared under substantially the same conditions as those for the sample 1 above except that, instead of capric acid amide as a fatty acid amide having an alkyl group added to the coating composition for magnetic layer, the lubricants shown in Table 1 below were individually added in an amount of 0.5 part by weight to the coating composition for forming a magnetic layer.

(Samples 7 to 12)

Samples 7 to 12 were individually prepared under substantially the same conditions as those for the sample 1 above except that no capric acid amide as a fatty acid amide having an alkyl group was added to the coating composition for magnetic layer, and that the lubricants shown in Table 1 below were individually added in an amount of 0.5 part by weight to the coating composition for nonmagnetic layer.

(Sample 13)

Sample 13 was prepared under substantially the same conditions as those for the sample 1 above except that, instead of capric acid amide, 0.5 part by weight of stearamide as a fatty acid amide having an alkyl group was added to the coating composition for magnetic layer, and that 0.5 part by weight of stearamide was added to the coating composition for nonmagnetic layer.

(Sample 14)

Sample 14 was prepared under substantially the same conditions as those for the sample 1 above except that no capric acid amide was added to the coating composition for magnetic layer.

(Sample 15)

Sample 15 was prepared under substantially the same conditions as those for the sample 1 above except that, instead of capric acid amide, 0.5 part by weight of heptylamide was added to the coating composition for magnetic layer.

(Sample 16)

Sample 16 was prepared under substantially the same conditions as those for the sample 1 above except that no capric acid amide was added to the coating composition for magnetic layer, and that 0.5 part by weight of heptylamide was added to the coating composition for nonmagnetic layer.

(Samples 17 to 20)

Samples 17 to 20 were individually prepared under substantially the same conditions as those for the sample 4 above except that the pH value of the nonmagnetic powder contained in the nonmagnetic layer was changed to the pH values shown in Table 1 below.

(Samples 21 to 24)

Samples 21 to 24 were individually prepared under substantially the same conditions as those for the sample 10 above except that the pH value of the nonmagnetic powder contained in the nonmagnetic layer was changed to the pH values shown in Table 1 below.

(Sample 25)

Sample 25 was prepared under substantially the same conditions as those for the sample 10 above except that spherical titanium oxide powder having a particle size of 0.04 μm was used as the nonmagnetic powder contained in the nonmagnetic layer.

(Sample 26)

Sample 26 was prepared under substantially the same conditions as those for the sample 10 above except that no lapping treatment was conducted before incorporating the magnetic tape into a cartridge.

(Sample 27)

Sample 27 was prepared under substantially the same conditions as those for the sample 10 above except that, instead of a lapping tape having an abrasive material particle size of 5 μm, the lapping tape having an abrasive material particle size of 3 μm was used for lapping treatment.

(Sample 28)

Sample 28 was prepared under substantially the same conditions as those for the sample 10 above except that, instead of the lapping tape having an abrasive material particle size of 5 μm, one having an abrasive material particle size of 9 μm was used for lapping treatment.

(Sample 29)

Sample 29 was prepared under substantially the same conditions as those for the sample 10 above except that, instead of the lapping tape having an abrasive material particle size of 5 μm, one having an abrasive material particle size of 16 μm was used for lapping treatment.

TABLE 1

| | NONMAGNETIC POWDER | | | LUBRICANT | | | | LAPPING |
|---|---|---|---|---|---|---|---|---|
| | NONMAGNETIC LAYER | | | MAGNETIC LAYER | | NONMAGNETIC LAYER | | TAPE |
| | | | AMOUNT | | AMOUNT | | AMOUNT | ABRASIVE |
| | | | OF ADDING | | OF ADDING | | OF ADDING | MATERIAL |
| | | | (PARTS BY | | (PARTS | | (PARTS | PARTICLE |
| | TYPE | PH | WEIGHT) | TYPE | BY WEIGHT) | TYPE | BY WEIGHT) | SIZE |
| SAMPLE 1 | α-Fe203 | 8.1 | 100 | CAPRIC ACID AMIDE | 0.5 | — | — | 5 |
| SAMPLE 2 | α-Fe203 | 8.1 | 100 | DODECYL ACID | 0.5 | — | — | 5 |
| | | | | AMIDE | | | | |
| SAMPLE 3 | α-Fe203 | 8.1 | 100 | MYRISTIC AMIDE | 0.5 | — | — | 5 |
| SAMPLE 4 | α-Fe203 | 8.1 | 100 | STEARAMIDE | 0.5 | — | — | 5 |
| SAMPLE 5 | α-Fe203 | 8.1 | 100 | OLEAMIDE | 0.5 | — | — | 5 |
| SAMPLE 6 | α-Fe203 | 8.1 | 100 | ERUCAMIDE | 0.5 | — | — | 5 |
| SAMPLE 7 | α-Fe203 | 8.1 | 100 | — | — | CAPRIC ACID AMIDE | 1.0 | 5 |
| SAMPLE 8 | α-Fe203 | 8.1 | 100 | — | — | DODECYL ACID | 1.0 | 5 |
| | | | | | | AMIDE | | |
| SAMPLE 9 | α-Fe203 | 8.1 | 100 | — | — | MYRISTIC AMIDE | 1.0 | 5 |
| SAMPLE 10 | α-Fe203 | 8.1 | 100 | — | — | STEARAMIDE | 1.0 | 5 |
| SAMPLE 11 | α-Fe203 | 8.1 | 100 | — | — | OLEAMIDE | 1.0 | 5 |
| SAMPLE 12 | α-Fe203 | 8.1 | 100 | — | — | ERUCAMIDE | 1.0 | 5 |
| SAMPLE 13 | α-Fe203 | 8.1 | 100 | STEARAMIDE | 0.5 | STEARAMIDE | 1.0 | 5 |
| SAMPLE 14 | α-Fe203 | 8.1 | 100 | — | — | — | — | 5 |
| SAMPLE 15 | α-Fe203 | 8.1 | 100 | HEPTYL AMIDE | 0.5 | — | — | 5 |
| SAMPLE 16 | α-Fe203 | 8.1 | 100 | — | — | HEPTYL AMIDE | 1.0 | 5 |
| SAMPLE 17 | α-Fe203 | 9.0 | 100 | STEARAMIDE | 0.5 | — | — | 5 |
| SAMPLE 18 | α-Fe203 | 7.6 | 100 | STEARAMIDE | 0.5 | — | — | 5 |
| SAMPLE 19 | α-Fe203 | 6.5 | 100 | STEARAMIDE | 0.5 | — | — | 5 |
| SAMPLE 20 | α-Fe203 | 5.8 | 100 | STEARAMIDE | 0.5 | — | — | 5 |
| SAMPLE 21 | α-Fe203 | 9.0 | 100 | — | — | STEARAMIDE | 1.0 | 5 |
| SAMPLE 22 | α-Fe203 | 7.6 | 100 | — | — | STEARAMIDE | 1.0 | 5 |
| SAMPLE 23 | α-Fe203 | 6.5 | 100 | — | — | STEARAMIDE | 1.0 | 5 |
| SAMPLE 24 | α-Fe203 | 5.8 | 100 | — | — | STEARAMIDE | 1.0 | 5 |
| SAMPLE 25 | TiO2 | 9.3 | 100 | — | — | STEARAMIDE | 1.0 | 5 |
| SAMPLE 26 | α-Fe203 | 8.1 | 100 | — | — | STEARAMIDE | 1.0 | — |
| SAMPLE 27 | α-Fe203 | 8.1 | 100 | — | — | STEARAMIDE | 1.0 | 3 |
| SAMPLE 28 | α-Fe203 | 8.1 | 100 | — | — | STEARAMIDE | 1.0 | 9 |
| SAMPLE 29 | α-Fe203 | 8.1 | 100 | — | — | STEARAMIDE | 1.0 | 16 |

The magnetic recording media of the above-prepared samples 1 to 29 having values of shield portion applied voltage, shortest recording wavelength, and wear depth of sendust bar shown in Table 2 below were used as Examples 1 to 22 and Comparative Examples 1 to 11.

The methods for measurements are described below.

(Shield Portion Applied Voltage)

DLT-1 drive, manufactured and sold by Quantum Corporation, U.S.A., was used.

A drive having no voltage applied to the shield portion was prepared by cutting a cable for applying a voltage to the shield portion.

(Shortest Recording Wavelength)

DLT-1 drive, manufactured and sold by Quantum Corporation, U.S.A., was used.

The shortest recording wavelength of DLT-1 drive is 0.55 μm. The magnetic tape speed was halved during the recording to create a shortest recording wavelength of 0.275 μm.

Further, the magnetic tape speed was increased 1.5 time during the recording to create a shortest recording wavelength of 0.825 μm.

(Wear Depth of Sendust Bar)

A measurement for depth of wear was conducted using a prism (4.5 mm square) wear bar comprised of a material having a composition: Al:Fe:Si=5.4:85.0:9.6 (wt %) under the following conditions.
Tape length: 500 m×20 cycles
Tape speed: 3.3 m/sec
Load: 100 g
Bar lap angle: 12 degrees
Temperature and humidity: 50% RH at 23° C.

With respect to the wear bar treated under the above conditions, a wear depth was measured using an optical microscope at a magnification of 400.

TABLE 2

| | | SHIELD | SHORTEST | |
|---|---|---|---|---|
| | | PORTION | RECORDING | WEAR DEPTH |
| | | APPLIED | WAVELENGTH | OF SENDUST |
| | SAMPLE | VOLTAGE (V) | (μm) | BAR (μm) |
| EXAMPLE 1 | SAMPLE 1 | 2 | 0.275 | 20 |
| EXAMPLE 2 | SAMPLE 2 | 2 | 0.275 | 20 |
| EXAMPLE 3 | SAMPLE 3 | 2 | 0.275 | 20 |
| EXAMPLE 4 | SAMPLE 4 | 2 | 0.275 | 20 |
| EXAMPLE 5 | SAMPLE 5 | 2 | 0.275 | 20 |
| EXAMPLE 6 | SAMPLE 6 | 2 | 0.275 | 20 |
| EXAMPLE 7 | SAMPLE 7 | 2 | 0.275 | 20 |
| EXAMPLE 8 | SAMPLE 8 | 2 | 0.275 | 20 |
| EXAMPLE 9 | SAMPLE 9 | 2 | 0.275 | 20 |
| EXAMPLE 10 | SAMPLE 10 | 2 | 0.275 | 20 |
| EXAMPLE 11 | SAMPLE 11 | 2 | 0.275 | 20 |
| EXAMPLE 12 | SAMPLE 12 | 2 | 0.275 | 20 |
| EXAMPLE 13 | SAMPLE 13 | 2 | 0.275 | 20 |
| EXAMPLE 14 | SAMPLE 17 | 2 | 0.275 | 20 |
| EXAMPLE 15 | SAMPLE 18 | 2 | 0.275 | 20 |
| EXAMPLE 16 | SAMPLE 21 | 2 | 0.275 | 20 |
| EXAMPLE 17 | SAMPLE 22 | 2 | 0.275 | 20 |
| EXAMPLE 18 | SAMPLE 25 | 2 | 0.275 | 20 |
| EXAMPLE 19 | SAMPLE 10 | 0 | 0.275 | 20 |
| EXAMPLE 20 | SAMPLE 10 | 2 | 0.550 | 20 |
| EXAMPLE 21 | SAMPLE 27 | 2 | 0.275 | 35 |
| EXAMPLE 22 | SAMPLE 28 | 2 | 0.275 | 10 |
| COMPARATIVE | SAMPLE 14 | 2 | 0.275 | 20 |
| EXAMPLE 1 | | | | |
| COMPARATIVE | SAMPLE 15 | 2 | 0.275 | 20 |
| EXAMPLE 2 | | | | |
| COMPARATIVE | SAMPLE 16 | 2 | 0.275 | 20 |
| EXAMPLE 3 | | | | |
| COMPARATIVE | SAMPLE 19 | 2 | 0.275 | 20 |
| EXAMPLE 4 | | | | |
| COMPARATIVE | SAMPLE 20 | 2 | 0.275 | 20 |
| EXAMPLE 5 | | | | |
| COMPARATIVE | SAMPLE 23 | 2 | 0.275 | 20 |
| EXAMPLE 6 | | | | |
| COMPARATIVE | SAMPLE 24 | 2 | 0.275 | 20 |
| EXAMPLE 7 | | | | |
| COMPARATIVE | SAMPLE 14 | 2 | 0.550 | 20 |
| EXAMPLE 8 | | | | |
| COMPARATIVE | SAMPLE 14 | 2 | 0.825 | 20 |
| EXAMPLE 9 | | | | |
| COMPARATIVE | SAMPLE 26 | 2 | 0.275 | 50 |
| EXAMPLE 10 | | | | |
| COMPARATIVE | SAMPLE 29 | 2 | 0.275 | 5 |
| EXAMPLE 11 | | | | |

With respect to each of Examples 1 to 22 and Comparative Examples 1 to 11, evaluations of the running reliability, the seizing amount on the magnetic head, the wear rate of the magnetic head, and the reproduction power were carried out.

[Reliability (Running Reliability)]

For evaluating the reliability, using VS160 drive, manufactured and sold by Quantam Corporation, a magnetic tape was allowed to run in 120 cycles (for about 20 days) while conducting a Read operation (for about 4 hours) for all tracks (168 tracks) under conditions at 50% RH at 23° C., and the number of cycles in which the error rate was rapidly increased in the 120 cycles was counted.

Specifically, the number of cycles in which the error rate was two times or more that of the previous cycle was counted. Evaluation was conducted with respect to 10 drives, and the numbers in the 10 drives of the cycles which exceeded the threshold in each drive were added together.

(Seizing Amount on Magnetic Head)

An unused magnetic head was evaluated with respect to the running reliability, and the resultant magnetic head was examined under an optical microscope (manufactured and sold by Nikon Corporation) to measure an area discolored.

The area was measured by taking the optical photomicrograph into a PC through a CCD and using a color extraction function of the image analysis soft (Win-Roof Ver 5.0, manufactured and sold by MITANI CORPORATION).

An average of the area values of seizing on the four magnetic heads for reproduction mounted on a head block was determined, and further an average of the values for 10 drives was determined.

(Wear Rate of Magnetic Head)

For the purpose of determining a wear rate of the magnetic head, an MR-MR resistance of the reproducing magnetic head was measured.

A reduction ratio of the MR-MR resistance after the evaluation of running reliability was measured.

(Reproduction Power)

The magnetic head of VS160 drive, manufactured and sold by Quantam Corporation, was mounted on ATS2 drive, manufactured and sold by Advanced Research Corporation, and a signal was recorded using PreAM-P2010, manufactured and sold by KYODO DENSHI SYSTEM CO., LTD.

Recording was conducted at a magnetic tape speed of 3.1 m/s at a recording frequency so that the shortest recording wavelength became 0.275 μm, 0.550 μm, or 0.825 μm to obtain a reproduction power.

Each of these magnetic tapes was reproduced by the same system using the magnetic head after the evaluation of running durability to determine a reduction ratio of the reproduction power.

TABLE 3

| | | SEIZING | WEAR RATE OF | REPRODUCTION |
|---|---|---|---|---|
| | RUNNING | AMOUNT | MAGNETIC HEAD | PERFORMANCE |
| | RELIABILITY | (μm2) | (%) | (%) |
| EXAMPLE 1 | 0 | 1.2 | 0.2 | ≦5 |
| EXAMPLE 2 | 0 | 1.0 | 0.2 | ≦5 |
| EXAMPLE 3 | 0 | 0.8 | 0.2 | ≦5 |
| EXAMPLE 4 | 0 | 0.6 | 0.2 | ≦5 |
| EXAMPLE 5 | 0 | 0.9 | 0.2 | ≦5 |
| EXAMPLE 6 | 0 | 1.3 | 0.2 | ≦5 |
| EXAMPLE 7 | 0 | 1.0 | 0.2 | ≦5 |
| EXAMPLE 8 | 0 | 0.8 | 0.2 | ≦5 |
| EXAMPLE 9 | 0 | 0.6 | 0.2 | ≦5 |
| EXAMPLE 10 | 0 | 0.5 | 0.2 | ≦5 |
| EXAMPLE 11 | 0 | 0.8 | 0.2 | ≦5 |
| EXAMPLE 12 | 0 | 1.2 | 0.2 | ≦5 |
| EXAMPLE 13 | 0 | 0.5 | 0.2 | ≦5 |
| EXAMPLE 14 | 0 | 0.4 | 0.2 | ≦5 |
| EXAMPLE 15 | 0 | 3.0 | 0.2 | ≦5 |
| EXAMPLE 16 | 0 | 0.5 | 0.2 | ≦5 |
| EXAMPLE 17 | 0 | 2.0 | 0.2 | ≦5 |
| EXAMPLE 18 | 0 | 0.6 | 0.2 | ≦5 |
| EXAMPLE 19 | 0 | 0.5 | 0.2 | ≦5 |
| EXAMPLE 20 | 0 | 0.5 | 0.2 | ≦5 |
| EXAMPLE 21 | 0 | 0.3 | 1.0 | ≦5 |
| EXAMPLE 22 | 0 | 1.0 | 0.1 | ≦5 |
| COMPARATIVE | 31 | 19 | 0.2 | 29 |
| EXAMPLE 1 | | | | |
| COMPARATIVE | 7 | 13 | 0.2 | 23 |
| EXAMPLE 2 | | | | |
| COMPARATIVE | 5 | 11 | 0.2 | 18 |
| EXAMPLE 3 | | | | |
| COMPARATIVE | 5 | 12 | 0.2 | ≦5 |
| EXAMPLE 4 | | | | |
| COMPARATIVE | 9 | 17 | 0.2 | ≦5 |
| EXAMPLE 5 | | | | |
| COMPARATIVE | 13 | 10 | 0.2 | ≦5 |
| EXAMPLE 6 | | | | |
| COMPARATIVE | 28 | 15 | 0.2 | ≦5 |
| EXAMPLE 7 | | | | |
| COMPARATIVE | 0 | 15 | 0.2 | 20 |
| EXAMPLE 8 | | | | |
| COMPARATIVE | 0 | 15 | 0.2 | ≦5 |
| EXAMPLE 9 | | | | |
| COMPARATIVE | 0 | 0.1 | 3.0 | ≦5 |
| EXAMPLE 10 | | | | |
| COMPARATIVE | 0 | 10 | 0.1 OR LESS | ≦5 |
| EXAMPLE 11 | | | | |

As can be seen from the Table 3 above, in the magnetic tapes in Examples 1 to 22 in which the nonmagnetic layer contained nonmagnetic powder having pH of 7.5 or more and the nonmagnetic layer or/and the magnetic layer contained at least one fatty acid amide having an alkyl group having 8 or more carbon atoms, evaluation of the running reliability was excellent, the seizing amount on the magnetic head was small, the wear rate of the magnetic head was suppressed, and the lowering of the reproduction power during running of the magnetic tape for a long time was extremely small.

On the other hand, in Comparative Example 1 in which neither the nonmagnetic layer 2 nor the magnetic layer 3 contained a fatty acid amide having an alkyl group having 8 or more carbon atoms, a phenomenon such that the error rate was rapidly increased frequently occurred, thus lowering the running reliability.

In addition, in Comparative Examples 2 and 3 in which the nonmagnetic layer 2 or magnetic layer 3 contained a fatty acid amide having less than 8 carbon atoms, a satisfactory effect of suppressing the error rate was not obtained, and further a satisfactory effect of lowering the seizing amount on the magnetic head was not obtained, and thus the reproduction power was remarkably lowered during running of the magnetic tape for a long time.

Further, in Comparative Examples 4 to 7 in which the nonmagnetic layer 2 contained nonmagnetic powder having pH of less than 7.5, a satisfactory effect of suppressing the error rate was not obtained, and further a satisfactory effect of lowering the seizing amount on the magnetic head was not obtained.

From Example 18, it has been found that, when pH of the nonmagnetic powder contained in the nonmagnetic layer 2 is 7.5 or more, irrespective of the type of the nonmagnetic powder, an effect of suppressing a rapid increase of the error rate can be obtained.

In addition, from Example 19, it has been found that, when the magnetic recording medium of the present invention is used in a system having no voltage applied to the shield portion, practically satisfactory running reliability can be obtained, the seizing amount on the magnetic head and the wear rate of the magnetic head are small, and excellent reproduction power can be maintained.

Further, from a comparison between Example 20 and Comparative Examples 8 and 9, it has been found that, even when the recording density is increased, by virtue of the nonmagnetic layer containing stearamide, evaluation of the running reliability is excellent, the seizing amount on the magnetic head is small, the wear rate of the magnetic head is suppressed, and high reproduction power can be maintained during running of the magnetic tape for a long time.

From a comparison between Comparative Examples 8 and 9, it has been found that, in Comparative Example 8 in which the recording density is higher, the lowering of the reproduction power due to seizing on the magnetic head is more remarkable.

Further, the results of Examples 21 and 22 and Comparative Examples 10 and 11 have confirmed that, by specifying the sendust bar wear depth to be 8 to 40 μm, both suppression of the seizing amount on the magnetic head and prevention of wear of the magnetic head can be achieved.

[Brief Description of the Drawings]

1. A magnetic recording medium, in tape form, which reproduces a magnetic recorded signal by a reproducing magnetic head utilizing a magnetoresistive effect element, the magnetic recording medium comprising:
a nonmagnetic layer in which nonmagnetic powder dispersed in a binder, and a magnetic layer comprising ferromagnetic powder dispersed in a binder, the nonmagnetic layer and the magnetic layer are successively formed on a long tape-like nonmagnetic substrate,
wherein the nonmagnetic layer contains the nonmagnetic powder having pH of 7.5 or more, and
wherein the nonmagnetic layer or/and the magnetic layer contain at least one fatty acid amide having an alkyl group having 8 or more carbon atoms.

2. The magnetic recording medium according to claim 1, the magnetic recording medium is utilized in a system having a voltage applied to a shield portion of the reproducing magnetic head.

3. The magnetic recording medium according to claim 1, the magnetic recording medium is utilized in a magnetic recording-reproducing system in which a shortest recording wavelength is 0.6 μm or less.

4. The magnetic recording medium according to claim 1, the magnetic recording medium is utilized in a magnetic recording-reproducing system in which a shortest recording wavelength is 0.4 μm or less.

5. The magnetic recording medium according to claim 1, wherein a sendust bar wear amount of the magnetic recording medium as measured under a condition with a humidity of 50% RH and a temperature of 23° C. is 8 to 40 μm.
